(19) United States
(12) Patent Application Publication
(10) Pub. No.: US 2012/0209665 A1
(43) Pub. Date: Aug. 16, 2012

(54) Idea, Submission, Ranking And Incubating System And Method

(75) Inventors: Matthew Crowe, Palo Alto, CA (US); Jason Rocco Chappie, Scotts Valley, CA (US); Charles W. Hollenhorst, Deephaven, MN (US); Jason Patrick Hardy, Edina, MN (US); Eric Taylor, St. Paul, MN (US); Aaron Bolanos, Campbell, CA (US)

(73) Assignee: Ahhha, Incorporated, Excelsior, MN (US)

(21) Appl. No.: 13/365,251

(22) Filed: Feb. 2, 2012

Related U.S. Application Data
(60) Provisional application No. 61/441,806, filed on Feb. 11, 2011.

(51) Int. Cl. G06Q 99/00

(52) U.S. Cl. 705/12

(57) ABSTRACT

A system and method for idea submission, idea ranking and idea incubating are provided that allow regular members of the public to submit ideas, allows those submitted ideas to be ranked and reviewed by a community and that incubates the best ideas and secures protection and potential monetization of the best ideas and it is to this end that the disclosure is directed.

### PRIORITY CLAIM/RELATED APPLICATIONS

This application claims the benefit under 35 USC 119(e) to U.S. Provisional Patent Application Ser. No. 61/441,806 filed on Feb. 11, 2011 and entitled “Idea Submission, Ranking And Incubating System And Method”, the entirety of which is incorporated herein by reference.

### FIELD

The disclosure relates generally to a system and method for idea submission, idea ranking and idea incubating.

### BACKGROUND

Systems exist that allow members of the public to submit a new idea for a particular product. A number of large corporations have programs to encourage members of the public to submit an idea that is somehow related to the on-going business of that particular large corporation. The limitation of these systems is that they do not incubate or rate the ideas that are submitted.

There are also companies who want to assist inventive people with the patent application process for a predetermined cost, such as LegalZoom who will prepare and file a provisional patent application. These services are directed to people who have the resources and pay for a provisional patent application, but do not service those people who have a good idea, but not the financial resources.

Thus, it is desirable to provide a system and method for idea submission, idea ranking and idea incubating that allows regular members of the public to submit ideas, allows those submitted ideas to be ranked and reviewed by a community and that incubates the best ideas and secures protection of the best ideas and it is to this end that the disclosure is directed.

### BRIEF DESCRIPTION OF THE DRAWINGS

FIG. 1 illustrates an example of a web implementation of an idea submission, ranking and incubating system;

FIG. 2 is a flowchart of an idea process;

FIG. 3 illustrates more details of the idea submission process that may be implemented by the idea system;

FIGS. 4A-4C illustrate examples of the idea submission user interface of the idea system;

FIGS. 5A and 5B illustrate more details of the idea ranking process that may be implemented by the idea system;

FIGS. 6A-6B illustrate examples of the idea ranking user interface of the idea system; and

FIG. 7 illustrates more details of the idea monetization process that may be implemented by the idea system.

### DETAILED DESCRIPTION OF ONE OR MORE EMBODIMENTS

The disclosure is particularly applicable to a web-based system and it is in this context that the disclosure will be described. It will be appreciated, however, that the system and method has greater utility since it can be implemented using other architectures, hardware or software that is within the scope of the disclosure.

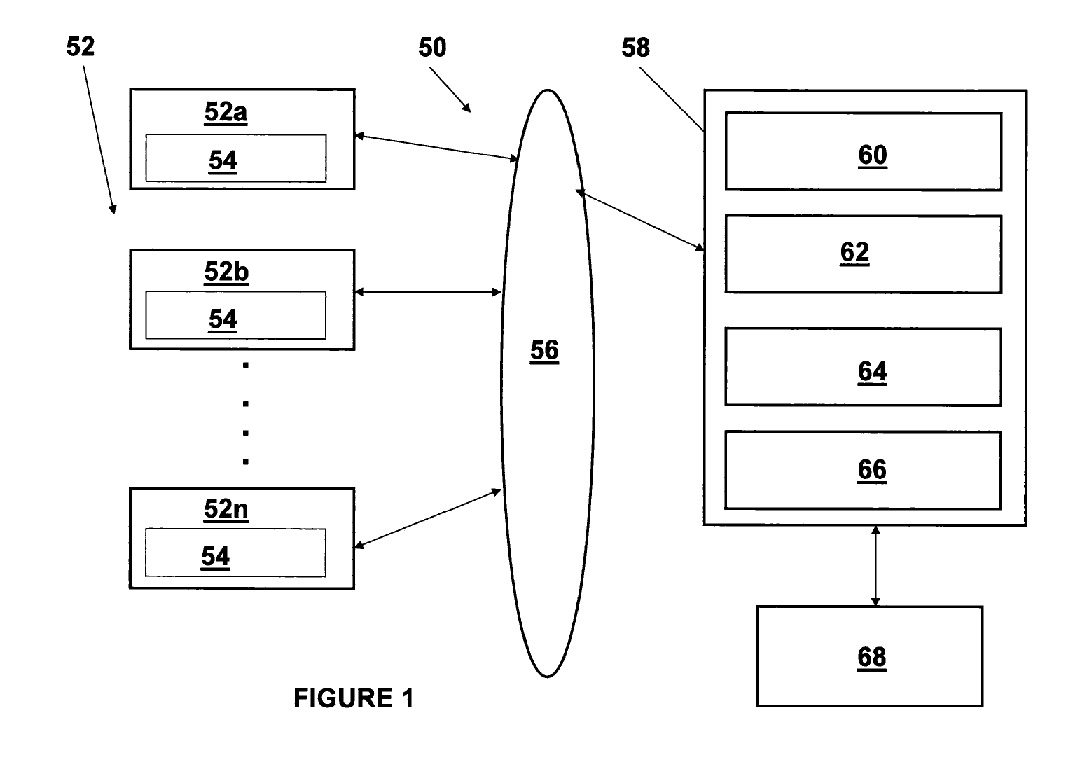

FIG. 1 illustrates an example of a web implementation of an idea submission, ranking and incubating system 50. The system 50 may have one or more computing devices 52, such as computing devices 52a, 52b, . . . 52n as shown in FIG. 1) that establish contact with, communicate with and exchange data with an idea unit 58 over a link 56. Each computing device 52 may be a device with one or more processing unit(s), memory, storage, wireless or wired connectivity capabilities and a display sufficient to permit the computing device 52 to interact with the idea unit 58 as described below. For example, each computing device 52 may be a desktop computer, a laptop computer, a tablet computer, a smartphone (Apple® iPhone®, RIM Blackberry®, devices that run the Android operating system), a terminal, a iPad or other slate computer and the like since the implementation of the system is not limited to any particular computing device. In one implementation, each computing device 52 may have a browser 54 that allows the user of the computing device to interact with the idea unit 58 as described below. The link 56 may be a digital data link that may be wired or wireless, may be a digital cellular network and/or a wireless or wired computer network since the implementation of the system is not limited to any particular link between the computing devices 52 and the idea unit 58.

The idea unit 58 may be, in one embodiment, one or more server computers that execute a plurality of line of computer code to implement the functions and operations of the idea unit 58 as described below. The idea unit 58 may also be implemented in hardware or a combination of hardware and software. In one implementation, the idea unit 58 may utilize, for example, a LAMP stack software bundle or other implementation that allows multiple computing devices in the client environment to be connected to a PHP/MySQL managed database and website user interface (commonly referred to as a Software as a Service, or SaaS). The idea 58 also may be implemented in a standalone computer system architecture, a cloud-based system with one or more computers over which the idea system is distributed, a mainframe type architecture, a downloadable application architecture and the like since the system is not limited to any particular architecture implementation.

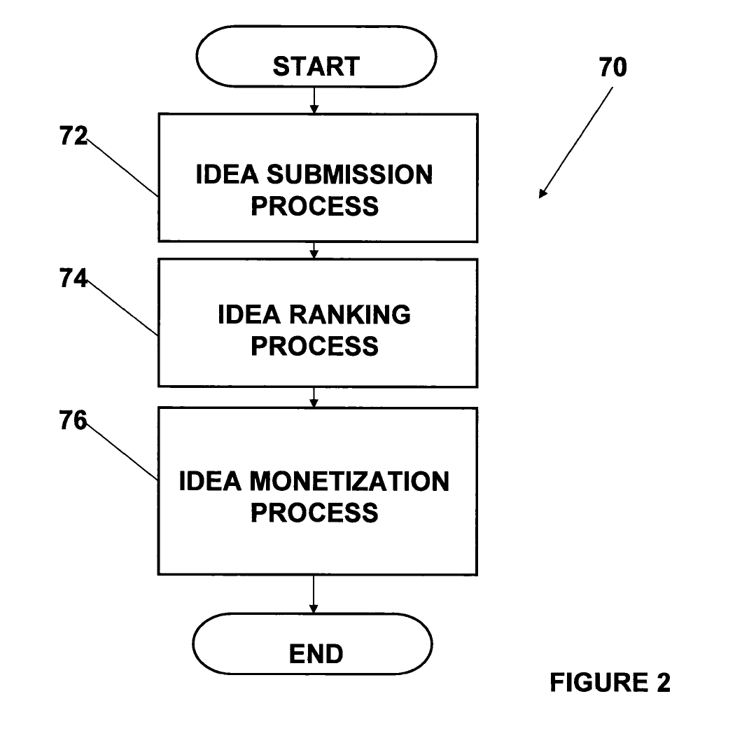

In the implementation shown in FIG. 1 (and as shown in the flowchart in FIG. 2), the idea unit 58 may further comprise a web server 60 (that may be software or hardware) that coordinates interactions with the computing devices, receives data from the computing devices and generates outputs, such as web pages, that are delivered to each computing device as needed, an idea submission unit 62 that manages and controls the process of idea submission (process 72 in FIG. 2) as described below in more detail, an idea ranking unit 64 that manages and controls the ranking of each idea by a community (process 74 in FIG. 2) as described below in more detail and an idea monetization unit 66 that manages and controls the process of monetizing an idea (process 76 in FIG. 2) as described below in more detail. The idea unit 58 may be coupled to a store 68, such as one or more databases for example, that stores the user data of the system, stored ideas (in an idea vault) and the like. The units 60-66 and store 68 may be implemented in hardware or software.

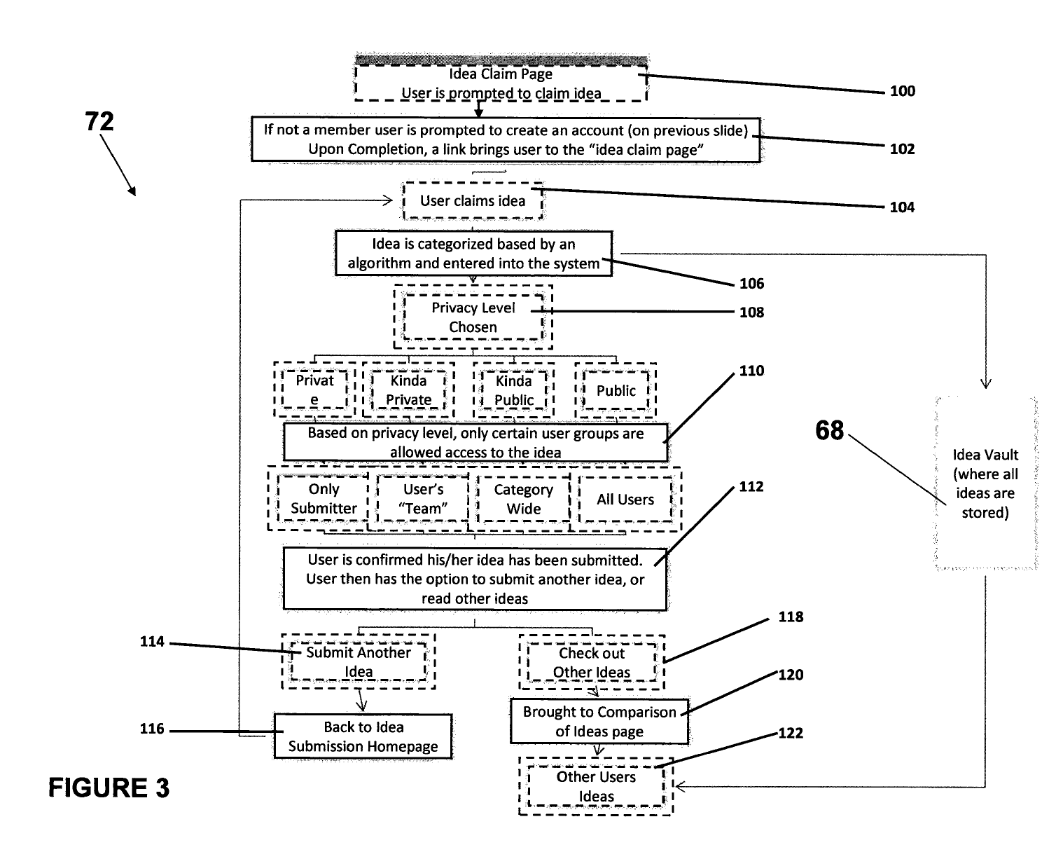

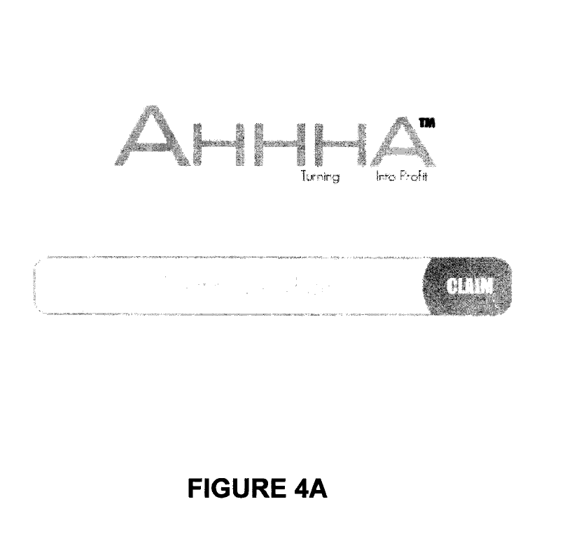

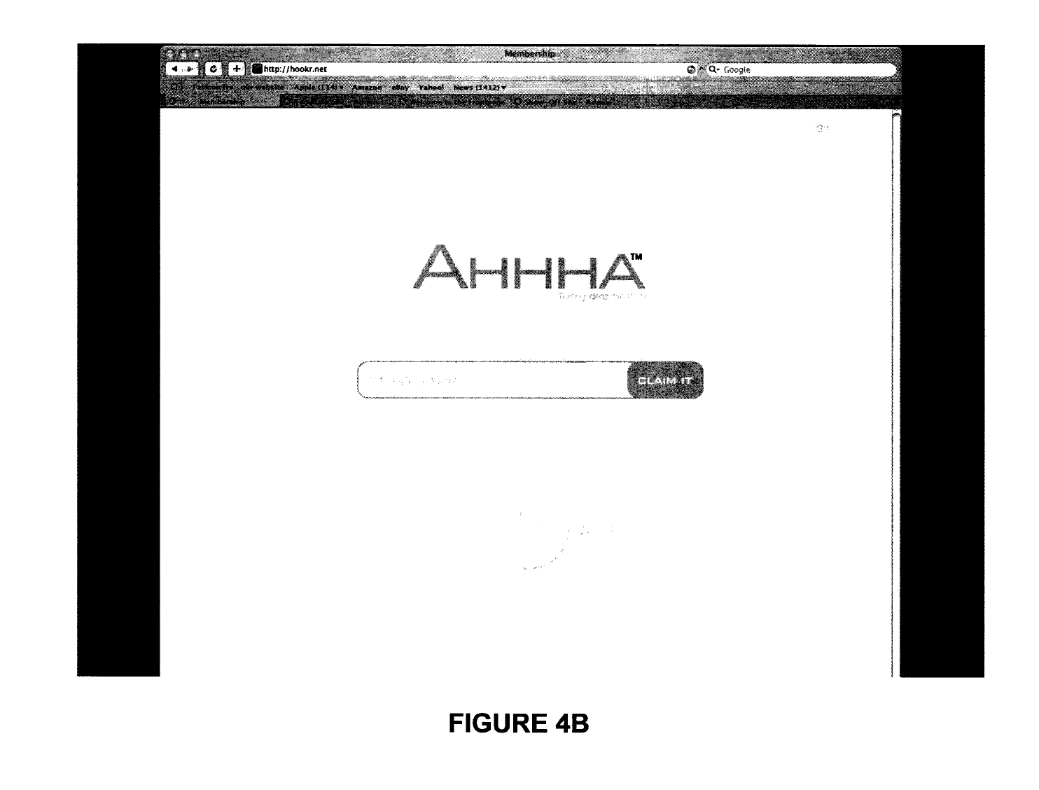

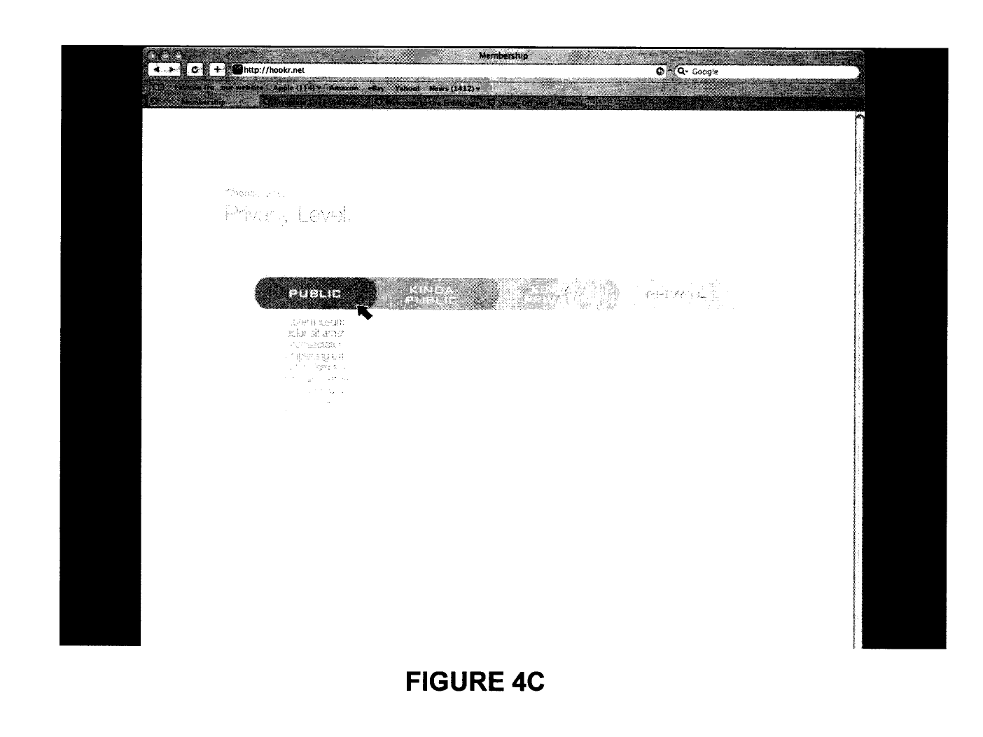

FIG. 3 illustrates more details of the idea submission process 72 that may be implemented by the idea system. In FIG. 3, items shown in black (solid lines) are the processing of the system and the idea submission unit processes while the items shown in dashed boxes are the user interface/experience during the idea submission process. Initially, an idea claiming user interface is presented to the user and the user is prompted to claim the idea (100). Two examples of the user interface for idea claiming as shown in FIGS. 4A and 4B. In the example in FIG. 4B, the user interface may also have a link to watch a video. If the user who claimed an idea is not a member of the idea system, the user is prompted to create an account and then a link brings the user to the idea claim user interface once the user is a member (102). The user then claims the idea (104) by entering the idea into the user interface using an input device, such as a touchscreen, keyboard, mouse, voice recognition system of the computing device.

Once the idea has been submitted by the user, the idea is categorized by the idea submission unit based on various data (including keywords contained in the claimed idea) and stored in the store 68 (106) in the idea vault. The idea may also be categorized after the idea ranking process. The categorization determines what other ideas the user who submitted the ideas sees and is asked to vote on most often. In particular, using data collected for the idea during the idea submission process as well as the idea ranking process (a classification of idea based on industry and type, as well as the number of votes it receives), the system can determine how and when to push each idea down the different paths to monetization that are described below. In particular, the specific paths to monetization for each idea may be determined by an idea unit code given to the particular idea when each idea is entered into the system and move through the process, as well as by the popularity score of the idea has from community of users of the idea system. The classification of ideas based on industry and type could best be described as a “zip” code for ideas based on the industry, supersector, sector, subsector the idea is in (very similar to the GICS codes) as well as the type of idea it is. Below are two examples of ideas and the code that is assigned to each idea:

Example Idea #1: A truck that comes to your house once a week at night and fills your car up with gas, then bills you at the end of the month based on how much gas they put in your car.

This idea would be categorized as follows:

| | | |
|---|---|---|
| Industry → | Energy | Code: 0000 |
| Supersector → | Oil & Gas | Code: 0500 |
| Sector → | Oil Equipment, Services & Distribution | Code: 0570 |
| Subsector → | Oil Equipment & Services | Code: 0573 |

wherein the underlined number is the number selected based on the particular category (for example a “5” for the oil and gas supersector and a “3” for the oil equipment and services subsector).

Example Idea #2: A blanket with sleeves (the Snuggie)

| | | |
|---|---|---|
| Industry → | Consumer Goods | Code: 3000 |
| Supersector → | Personal & Household goods | Code: 3700 |
| Sector → | Personal Goods | Code: 3760 |
| Subsector → | Clothing & Accessories | Code: 3763 |

wherein the underlined number is the number selected based on the particular category (for example a “3” for the consumer goods industry and a “6” for the personal goods sector).

In addition to the industry/sector classification code for a particular idea, the idea system assigns each idea a classification based on the type of idea it is. For example:

| | |
|---|---|
| Idea for a new product or service | Code: N |
| Idea for a new standalone business | Code: B |
| Idea for an improvement on a product or service | Code: I |
| Idea for a new use of something or way to way to do | Code: W |
| something | |
| Other idea | Code: O |

Using the gas truck example from above, the idea would be classified and have a code that is: 0573I (I for an improvement on a product or service). Using the Snuggie example from above, the idea would be classified and have a code that is: 3763N (N for an idea for a new product or service).

Returning to FIG. 3, after the idea has been categorized, the user select a privacy level for the idea from a privacy user interface (108). An example of the user interface for selecting the privacy level for each idea is shown in FIG. 4C. In one implementation, the system may permit the user to select a privacy level of “Private”, “Kinda Private”, “Kinda Public” and “Public.” Once the user selects a privacy level, the system set permissions of the idea that permit a certain group of users to access/view/vote/comment on the recently submitted idea (110). For example, for a “Private” idea, the system may only allow the user/submitter to view the submitted idea, for a “Kinda Private” idea, the system may allow the user to choose a number of users of the system or other people (who can then sign up to be a member) who can view/access/comment on the submitted idea, for a “Kinda Public” idea, the system may allow a category wide set of users (such as, for example, users who are cat owners for a cat scratching idea or oil/gas engineers for a gas/oil idea) to access/view/vote/comment the submitted idea, and for a “Public” idea, the system may allow all user of the idea system to access/view/vote/comment the submitted idea.

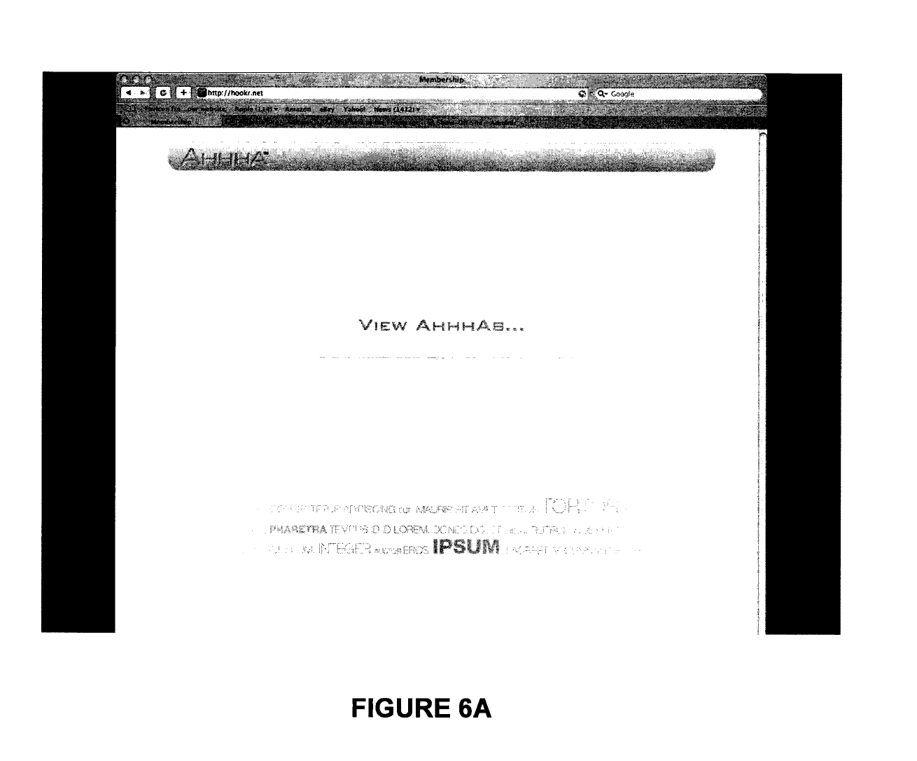

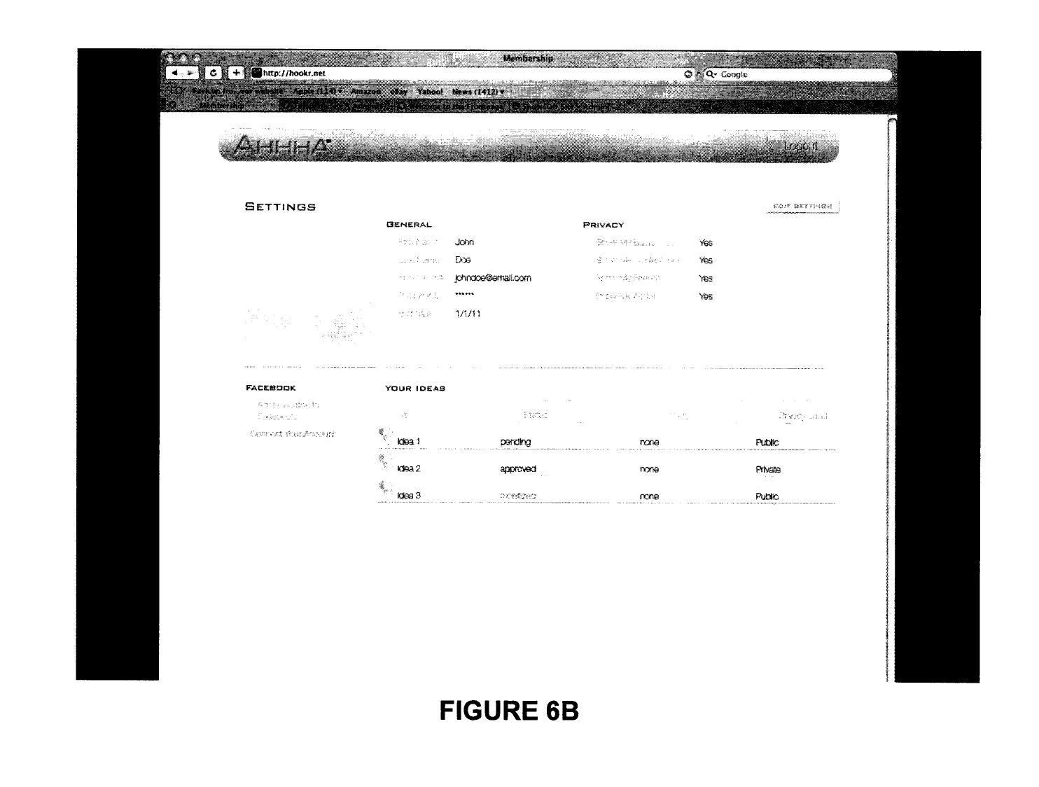

Once the idea's privacy level is selected, the system confirms that the user's idea has been submitted and the user is given the option to submit another idea or read other ideas (112). If user chooses to submit another idea (114), the user is returned to the “idea claim” homepage (116). If user chooses to see other ideas (118), the user is brought to a user interface (120), such as a web page, where the user they can read/comment on/vote on other ideas (122) that may be retrieved from the store 68 wherein the retrieved other ideas are selected based on the information in the user' profile and the type of ideas they submit so that the user sees other ideas the are most likely to interest the user. FIG. 6A illustrates an example of a user interface to see other ideas. Now, the idea ranking process is described in more detail.

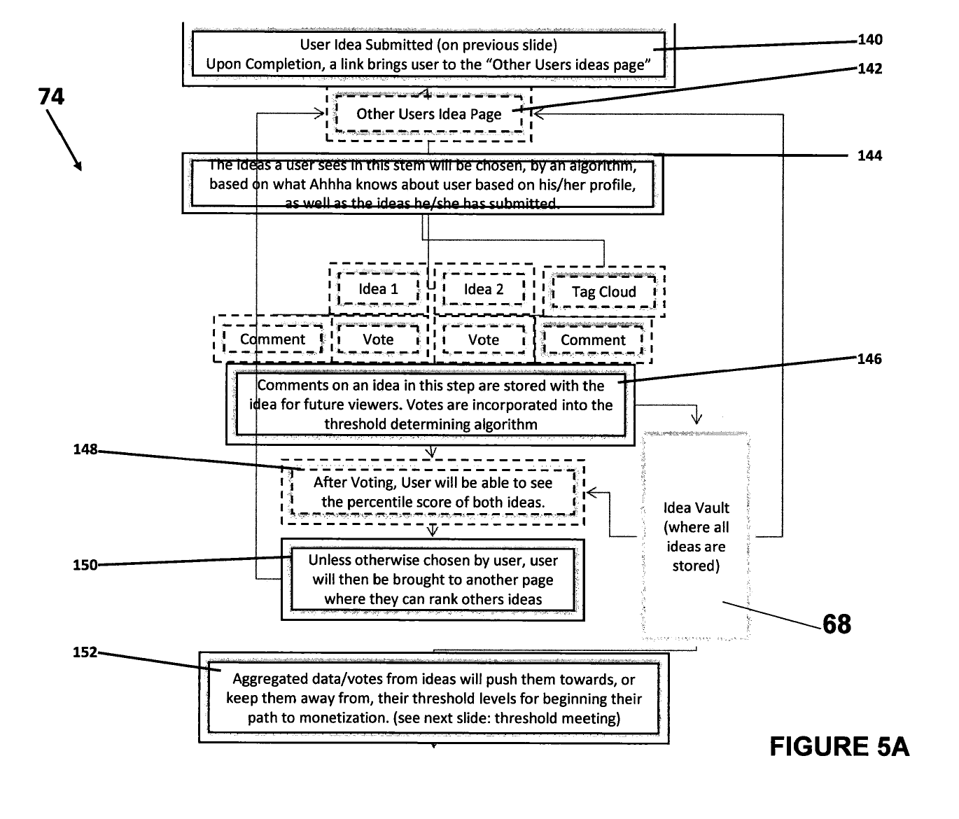

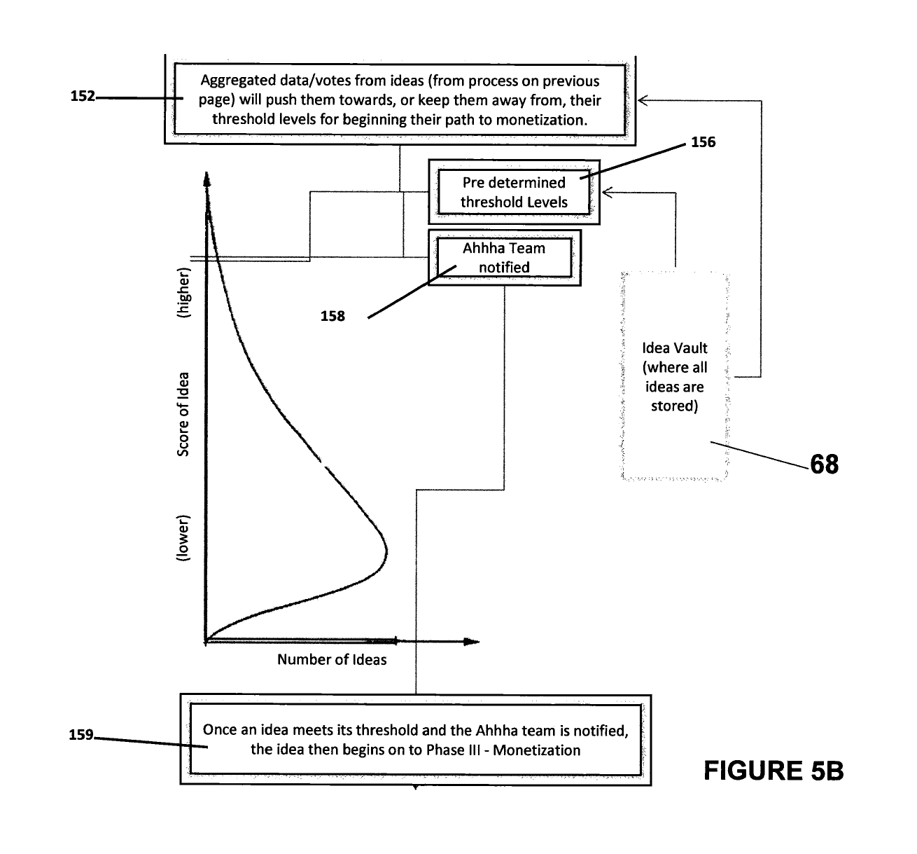

FIGS. 5A and 5B illustrate more details of the idea ranking process 74 that may be implemented by the idea ranking unit of the idea system. After the idea submission is completed, the idea ranking process may include a other users idea user interface (140,142) that retrieves ideas of other users from the store 68. The system retrieves the other ideas based on the information in the user' profile (see FIG. 6B for an example of the profile data of a user) and the type of ideas that the particular user has previously submitted so that the user sees other ideas the are most likely to interest the user (144). The user may be presented with one or more other user ideas (two ideas are presented in one implementation) as well as a tag cloud that shows the tags associated with the two displayed other user's ideas. In the user interface, the user also is presented with the comments from other users for the presented ideas. Using the user interface, the user is able to comment on each idea and vote of the idea which the user thinks is the best idea and the comments and/or voting information is saved in the system and associated with the particular idea (146). The votes may be used by a threshold determining process that is described below in more detail. To provide feedback/interaction with the user, after voting, the user will see a percentile score fore each idea (the data being retrieved from the store 68) has based on other users votes (148) as well as the user's vote. Then, unless the user chooses another option, once voting and feedback is completed, user will be brought to another user interface where they can vote on other ideas (150) and be returned to the other ideas user interface 142. As part of the idea ranking process, as all Ideas are presented in front of users for voting and data is accumulated and aggregated by an algorithm, ideas will approach, or stay away from, their tipping point levels with regard to when they begin their path to monetization (152).

FIG. 5B illustrates more details of the threshold determining process that is part of the idea ranking system. In the threshold determining process, based on data gathered from the original idea submission (type, market data from SIC code, etc.), a tentative pre-determined threshold level will be set (156). For example, for a particular type of product, a first threshold level is set whereas a different type of product will have a second threshold level. In addition, each user who votes/comments on an idea is given a score (that may vary depending, for example, on the expertise of the user in a particular area or other factors). For example, for the oil and gas idea, a user who is an oil and gas engineer by training may be given a higher score when he/she votes for the idea as compared to a student who does not have expertise in the area. To incentivize each user to vote/comment on ideas, the idea system may award E-notes to the user who can then trade the accumulated E-notes in for merchandise, money and the like. In the idea ranking system, the user's scores accumulates up to the threshold level for the particular idea. Once the threshold level is met for a particular idea, the system notifies an internal team when an idea meets its threshold (158). Once an idea meets its threshold and the Ahhha team is notified, the idea then moves to Phase III-Monetization (159).

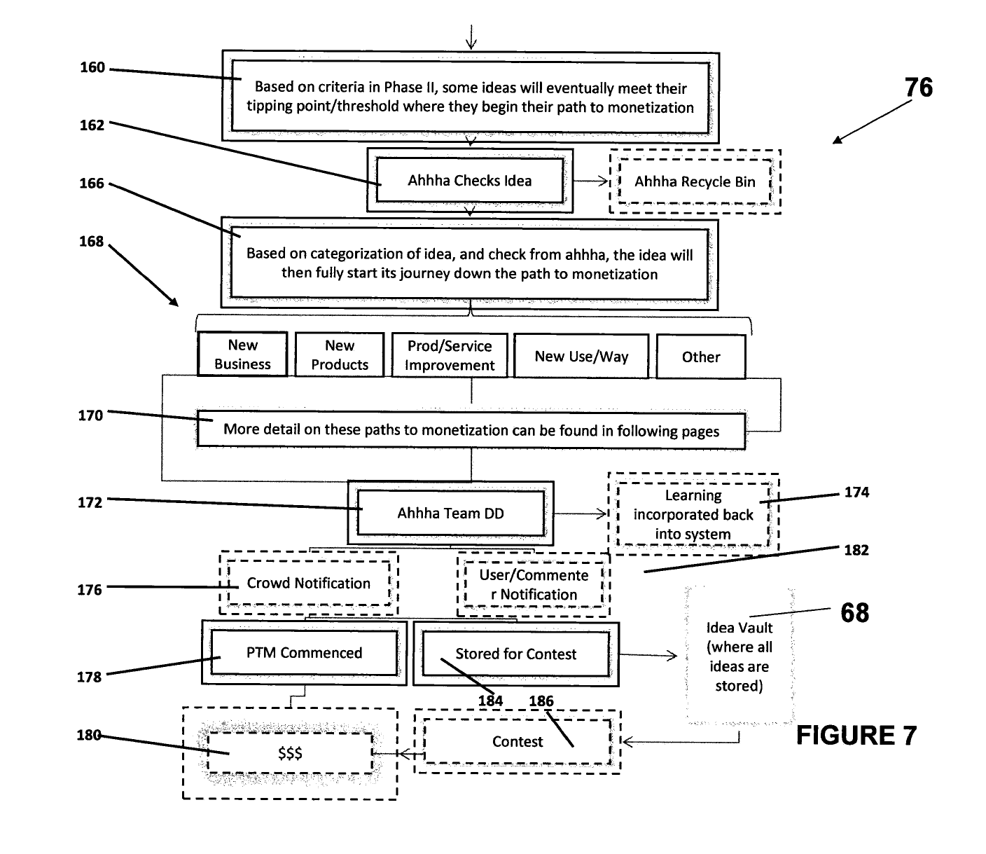

FIG. 7 illustrates more details of the idea monetization process 76 that may be implemented by the idea monetization unit of the idea system. During the idea monetization, some ideas will eventually meet their tipping point/threshold where they begin their path to monetization (160). Before substantial work is done, the system team checks the Idea (162) to make sure it is a real, executable, idea and is categorized correctly. The team places the idea is recycle bin if the idea is not real, executable, idea and/or is not categorized correctly so that the idea may be put back into the idea ranking process described above. The idea then begins its journey down its path to monetization (166). The system may have one or more paths to monetization that are chosen for each idea by the system. In one implementation, the paths to monetization may include: new business (form a new business around the idea), new products (make a new product based on the idea for an existing entity), product/service improvement, new use/way and/or other.

In more detail, based on the classification of the idea by its industry and type, as well as the popularity the idea has among users (during the idea ranking), the idea system selects the best path to monetization for the particular idea. The most common paths to monetization for ideas are below:
Sell product/service online in the AHHHA marketplace
Sell products/services online on other marketplaces
Sell the idea (or rights to/IP for idea)
Hold an online contest where users vote for who gets “prize money” to execute their idea—Money will come from AHHHA or an investment partner
Have an investment partner invest in/facilitate the execution of the idea
Provide tools and support for the submitter to execute their idea
Match up the idea with a start-up team who can/is willing to execute the idea

Therefore, continuing the gas example from above, based on the “AHHHA code” given to this idea, it could potentially be executed through our strategic partners in oil and gas services and monetized through our online marketplace, through helping the submitter set up this service, or the idea could be monetized by simply selling the idea (any rights/IP to it) to a gas distributer/retailer. The popularity that this idea has among AHHHA users as well as traditional due diligence will ultimately be the deciding factor of how this idea monetized. Continuing the Snuggie example from above, based on the “AHHHA code” given to this idea, it could potentially be executed through any one of our monetization channels. The popularity of this idea among AHHHA users as well as traditional business due diligence would ultimately lead to the decision of how this idea is monetized.

As this process is executed with ideas that come through the site, the idea system will learn/establish pre-determined threshold levels of popularity for ideas that, once hit, will give the idea system a great deal of certainty that the idea will be successfully executed. Until there is enough data to set specific threshold levels, AHHHA will look at the rank of ideas by industry and look for outliers on the popular side of the spectrum, and determine which of those to monetize.

Returning to FIG. 7, once the path to monetization is determined, the idea system team reviews fundamentals of idea (172), largely pulled from the system processes (SIC Code data and other market data) does other traditional due diligence to ensure idea is likely to be profitable), fills in blanks, confirms idea is topnotch, and packages it all up (using a standard template). The learning that is discovered during the due diligence may be fed back into the system (174) and then automatic notification emails are sent to friends/“inner circle” and people who commented on the idea as well as the user of the system (176, 182) about the idea and its monetization. For example, the idea may even be posted on a scrolling banner on the idea system user interface to inspire other users. After the notifications, the idea is either executed by the idea system team right away (178), or is placed back in the Idea vault, in a special queue for review for the Contest (186).

Using the idea system, everyday people can claim an idea, see if it has traction and then have the idea system determine an appropriate path to monetization for the idea.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An idea submission, ranking and monetization computer-based system, the system comprising:
one or more computing devices;
a computer-based idea system that interacts with the one or more computing devices for the submission of an idea;
the idea system having:
an idea submission unit that allows one of the one or more computing devices to submit an idea and select a privacy level for the idea, wherein the privacy levels are at least a private level and a public level;
an idea vault that stores the submitted ideas;
an idea ranking unit that permits a plurality of users of the system to one of vote and comment on a plurality of ideas stored in the system; and
an idea monetization unit that determines a path of monetization for an idea that has sufficient votes.

2. The system of claim 1, wherein each computing device has one or more processing units, a memory, a storage unit and a display to interact with the idea submission unit.

3. The system of claim 2, wherein each computing device one of a desktop computer, a laptop computer, a tablet computer, a smartphone, a terminal, a iPad and a slate computer.

4. The system of claim 1, wherein the idea system further comprises a computer.

5. The system of claim 4, wherein the computer is one of a standalone computer system, a cloud-based system, a mainframe type system, a downloadable application on a computer and a SaaS system.

6. The system of claim 1, wherein the idea submission unit prompts a user to claim an idea, categorizes the idea and stores the idea in the idea vault.

7. The system of claim 6, wherein the idea submission unit categorizes the idea by classifying the idea based on one or more of an industry of the idea and a type of idea.

8. The system of claim 7, wherein the idea submission unit classifies the idea by industry into an industry, a supersector, a sector and a subsector for the idea.

9. The system of claim 1, wherein the idea ranking unit permits a plurality of users to rank the idea when the privacy level is public.

10. The system of claim 1, wherein the idea ranking unit displays a set of ideas of other users from the idea store when the user is one of voting and commenting on the idea.

11. The system of claim 10, wherein the idea ranking unit displays the set of ideas of other users based on information in a profile of the user.

12. The system of claim 10, wherein the idea ranking unit displays a comment from other users for each of the set of ideas.

13. The system of claim 1, wherein the idea ranking unit has an idea thresholding process that sets the sufficient votes for the idea to be placed into the idea monetization unit.

14. The system of claim 1, wherein the idea ranking unit gives a score to each user that one of votes and comments on the idea based on an expertise of the user who one of votes and comments on the idea.

15. The system of claim 6, wherein the idea monetization unit determines a path to monetization based on the categorization of the idea.

16. The system of claim 6, wherein the idea monetization unit determines a path to monetization based on a number of votes of the idea.

17. The system of claim 1, wherein the paths to monetization are one of a new business, a new product, a product or service improvement and a new use or way.

18. A computer based idea submission, ranking and monetization method using a idea system, the method comprising:
submitting, using a computer based idea submission unit that is part of the idea system, an idea to the idea system;
selecting, by a user interface of the idea submission unit, a privacy level for the idea, wherein the privacy levels are at least a private level and a public level;
storing the idea in an idea vault of the idea system;
ranking, using a computer based idea ranking unit that is part of the idea system, each idea in the idea vault by permitting users of the system to one of vote and comment on a plurality of ideas stored in the system; and
determining, using a computer based idea monetization unit that is part of the idea system, a path of monetization for an idea that has sufficient votes based on the ranking of the idea.

19. The method of claim 18, wherein submitting the idea further comprising prompting the user to submit the idea, categorizing the idea and storing the idea in an idea vault.

20. The method of claim 19, wherein categorizing the idea further comprises classifying the idea based on one or more of an industry of the idea and a type of idea.

21. The method of claim 20, wherein the idea is classified by industry into an industry, a supersector, a sector and a subsector for the idea.

22. The method of claim 18, wherein a plurality of users to rank the idea when the privacy level is public.

23. The method of claim 18 further comprising displaying a set of ideas of other users from the idea store when the user is one of voting and commenting on the idea.

24. The method of claim 19, wherein displaying the set of ideas is based on information in a profile of the user.

25. The method of claim 19, wherein displaying the set of ideas further comprises displaying a comment from other users for each of the set of ideas.

26. The method of claim 18, wherein ranking of the idea further comprises performing an idea thresholding process that sets the sufficient votes for the idea to be placed into the idea monetization unit.

27. The method of claim 18, wherein ranking of the idea further comprises giving a score to each user that one of votes and comments on the idea based on an expertise of the user who one of votes and comments on the idea.

28. The method of claim 19, wherein determining a path to monetization further comprises determines a path to monetization based on the categorization of the idea.

29. The method of claim 19, wherein determining a path to monetization further comprises determining a path to monetization based on a number of votes of the idea.

30. The method of claim 18, wherein the paths to monetization are one of a new business, a new product, a product or service improvement and a new use or way.
